(19) United States
(12) Patent Application Publication
(10) Pub. No.: US 2016/0379327 A1
(43) Pub. Date: Dec. 29, 2016

(54) METHOD OF FACILITATING NATURAL DISASTER RELIEF PLANNING

(71) Applicant: MasterCard Asia/Pacific Pte. Ltd., Singapore (SG)

(72) Inventors: Suneel BHATT, Haryana (IN); Priyanka TANEJA, Haryana (IN); Ankur ARORA, Delhi (IN)

(21) Appl. No.: 15/191,311

(22) Filed: Jun. 23, 2016

(30) Foreign Application Priority Data
Jun. 29, 2015 (SG) 10201505172Y

(51) Int. Cl. G06Q 50/26; G06Q 30/02

(52) U.S. Cl. CPC G06Q 50/265; G06Q 30/0201

(57) ABSTRACT

A computer-implemented method for facilitating natural disaster relief planning, comprising: obtaining current payment-card transaction data after a natural disaster occurs; identifying distinct merchants whom payment-card holders have made payment-card transactions with after the natural disaster occurred based on the current payment-card transaction data; obtaining a location of each of the distinct merchants by referring to a database having stored thereon the location of each of the distinct merchants; and ranking each of the obtained locations based on the current payment-card transaction data, wherein natural disaster relief is provided at the obtained locations based on their ranking.

### RELATED APPLICATIONS

The present application claims priority to Singapore Patent Application 10201505172Y, entitled “Method for Facilitating Natural Disaster Relief Planning,” filed on Jun. 29, 2015.

### FIELD OF DISCLOSURE

The present disclosure relates broadly, but not exclusively, to methods for facilitating natural disaster relief planning.

### BACKGROUND

In the event of natural disasters or calamities occurring in a particular area, an affected population typically moves to another area that is safer. Usually, there is a lack of accurate information regarding the movement and location of the affected population, and what percentage of the affected population moves to which region/city/locality. Hence, providing relief to the affected population may be difficult. Additionally, product sales in the relief area may increase, for example, in certain industries such as food and medical supplies. Merchants in the relief area may not have sufficient inventory to cater to the demands of the affected population.

### SUMMARY

According to a first aspect of the present disclosure, there is provided a computer-implemented method for facilitating natural disaster relief planning, comprising: obtaining current payment-card transaction data after a natural disaster occurs; identifying distinct merchants whom payment-card holders have made payment-card transactions with after the natural disaster occurred based on the current payment-card transaction data; obtaining a location of each of the distinct merchants by referring to a database having stored thereon the location of each of the distinct merchants; and ranking each of the obtained locations based on the current payment-card transaction data, wherein natural disaster relief is provided at the obtained locations based on their ranking.

In an embodiment, each of the obtained locations may be ranked based on a count of the number of distinct payment-card holders whom have made payment-card transactions with each of the distinct merchants at each of the obtained locations.

In an embodiment, the method may further comprise: assigning each of the obtained locations to one of a plurality of sectors, each sector defining a geographical locality; and ranking each of the plurality of sectors based on the count of the number of distinct payment-card holders whom have made payment-card transactions with each of the distinct merchants at each of the obtained locations assigned to the sector.

In an embodiment, each of the obtained locations may be ranked based on a count of the number of payment-card transactions that have been made with each of the distinct merchants at each of the obtained locations.

In an embodiment, the method may further comprise: assigning each of the obtained locations to one of a plurality of sectors, each sector defining a geographical locality; and ranking each of the plurality of sectors based on the count of the number of payment-card transactions that have been made with each of the distinct merchants at each of the obtained locations assigned to the sector.

In an embodiment, the method may further comprise: obtaining an industry-type of each of the distinct merchants by referring to the database further having stored thereon the industry-type of each of the distinct merchants, wherein the obtained industry-type of each of the distinct merchants provide an indication of industries involved in payment-card transactions after the natural disaster occurred.

In an embodiment, the method may further comprise: obtaining historical payment-card transaction data before the natural disaster occurred; identifying additional distinct merchants whom the payment-card holders have made payment-card transactions with before the natural disaster occurred based on the historical payment-card transaction data; obtaining a location of each of the additional distinct merchants by referring to the database further having stored thereon the location of each of the additional distinct merchants; and comparing the location of each of the distinct merchants with the location of each of the additional distinct merchants to provide an indication of movement of the payment-card holders due to the natural disaster.

In an embodiment, each of the obtained locations may comprise geographical location data corresponding to the distinct merchant's premises. The geographical location data may comprise one or more of: (i) a latitude and longitude, and (ii) postal address.

In an embodiment, the current payment-card transaction data may comprise a merchant identity for uniquely identifying each of the distinct merchants.

In an embodiment, the method may further comprise storing, in the database, the merchant identity in association with the corresponding location of the distinct merchant.

According to a second aspect of the present disclosure, there is provided an apparatus for facilitating natural disaster relief planning, the apparatus comprising: at least one processor; and at least one memory including computer program code; the at least one memory and the computer program code configured to, with at least one processor, cause the apparatus at least to: obtain current payment-card transaction data after a natural disaster occurs; identify distinct merchants whom payment-card holders have made payment-card transactions with after the natural disaster occurred based on the current payment-card transaction data; obtain a location of each of the distinct merchants by referring to a database having stored thereon the location of each of the distinct merchants; and rank each of the obtained locations based on the current payment-card transaction data, wherein natural disaster relief is provided at the obtained locations based on their ranking.

### BRIEF DESCRIPTION OF THE DRAWINGS

Embodiments of the disclosure will be better understood and readily apparent to one of ordinary skill in the art from the following written description, by way of example only, and in conjunction with the drawings, in which:

FIG. 1 shows a flow chart illustrating a computer-implemented method for facilitating natural disaster relief planning, according to an example embodiment; and

FIG. 2 shows a schematic diagram of a computer system suitable for use in executing the method for facilitating natural disaster relief planning.

### DETAILED DESCRIPTION

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence leading to a result. The blocks are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the method, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the method may be appropriate. The structure of a computer will appear from the description below.

In addition, the present specification also implicitly discloses a computer program, in that it would be apparent to the person skilled in the art that the individual blocks of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the blocks of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the method.

Embodiments of the present disclosure relate to methods for facilitating natural disaster relief planning by locating payment-card holders based on transaction data. Relief may be provided at the locations of the payment-card holders. In the following description, a payment-card is a card that can be used by a holder (consumer) and accepted by a merchant to make a payment for a purchase of a product. The payment-card is usually linked to the consumer's bank account. Examples of payment-cards include debit, pre-paid and credit cards.

Typically, in a “card-present” transaction, when a payment-card holder (consumer) wishes to purchase a product from a merchant, the payment-card holder presents his/her payment-card to the merchant. The merchant then submits a request to an acquirer (a financial institution that processes and settles the merchant's transactions with the help of an issuer). The acquirer then sends the request to the issuer (a financial institution, bank, credit union or company that issues or helps issue cards to payment-card holders) to authorize the transaction. A financial institution/payment facilitator (e.g. MasterCard®) acts as an intermediary between the acquirer and the issuer. If the acquirer authorizes the transaction, the merchant releases the product to the payment-card holder.

The transaction authorization process described above involves multiple parties (payment-card holder, merchant, acquirer, issuer, payment facilitator). However, the transaction authorization process may be essentially viewed as a transaction between a payment-card holder and a merchant (with the other parties facilitating the transaction).

During the transaction, certain data associated with the transaction (i.e. transaction data) may be generated and the transaction data may be captured/collected by the payment facilitator. For example, the transaction data may be uploaded to a data warehouse on a regular basis (e.g. daily, weekly, monthly). If necessary, various algorithms/rules can be applied to anonymize the transaction data so that no personally identifiable numbers are available to the users of the transaction data.

The following types of transaction data can be may be generated/captured:
Transaction level information:
   Transaction ID
   Account ID (anonymized)
   Merchant ID
   Transaction Amount
   Transaction Local Currency Amount
   Date of Transaction
   Time of Transaction
   Type of Transaction
   Date of Processing
   Cardholder Present Code
   Merchant Category Code (MCC)
Account Information:
   Account ID (anonymized)
   Card Group Code
   Card Product Code
   Card Product Description
   Card Issuer Country
   Card Issuer ID
   Card Issuer Name
   Aggregate Card Issuer ID
   Aggregate Card Issuer Name
Merchant Information:
   Merchant ID
   Merchant Name
   MCC/Industry Code
   Industry Description
   Merchant Country
   Merchant Address
   Merchant Postal Code
   Aggregate Merchant ID
   Aggregate Merchant Name
   Merchant Acquirer Country
   Merchant Acquirer ID
Issuer Information:
   Issuer ID
   Issuer Name
   Aggregate Issuer ID
   Issuer Country

In the event of natural disasters or calamities occurring in a particular area, an affected population typically moves to another area/location that is safer. It can be expected that the affected population purchases products (goods or services) from merchants at the new area. For example, the affected population may need to purchase necessities (food, clothing, medical supplies, etc.). If the affected population uses a payment-card to purchase products from merchants at the new area (via a “card-present” transaction), it is can be assumed that payment-card holders are physically present at the merchants' location at the time of the transaction. Based on this assumption, it is possible to track the location of payment-card holders based on the transaction data that is generated from transactions made between the payment-card holders and merchants at the new area. Relief efforts can be provided at the location of the payment-card holders.

For each transaction that is made between a payment-card holder and a merchant, the corresponding transaction data may include information such as the identity of the merchant (“Merchant name” or “Merchant ID”), time and date of transaction, and the type of industry of the merchant (“Merchant Category Code (MCC)”).

The geographical location of the merchant may be stored in a database. In this context, geographical location data of the merchant may include latitude and longitude coordinates and a postal address. The latitude and longitude coordinates may be in any suitable format, such as: (i) Degrees, minutes, and seconds (DMS), (ii) Degrees and decimal minutes (DMM), and (iii) Decimal degrees (DD).

When a natural disaster (e.g. flood, volcanic eruption, earthquake, tsunami, etc.) occurs, the time and date of the occurrence is noted. Transaction data generated after the occurrence of the natural disaster is obtained. This is possible as each transaction typically has a corresponding time-stamp (i.e. date and time of transaction).

The obtained transaction data may be restricted to a certain city, region or country depending on the scale of the natural disaster and the expected migration pattern of the affected population. For example, a population affected by a localised flood occurring in a city is not expected to move to a new location far away from the flooded city. As such, the transaction data that is obtained may be restricted to regions surrounding the city. On the other hand, an earthquake affecting an entire country is expected to trigger large-scale movement of the affected population. Some of the affected population may even move to neighbouring countries. As such, the transaction data that is obtained may encompass a number of countries.

After the transaction data is obtained, the identity of the merchants that participated in the transactions can be obtained/extracted, for example, using the corresponding merchant ID. Once the merchants are identified, their respective locations can be obtained by referring to a database having stored thereon the location (e.g. postal address, latitude/longitude) of each merchant in association with the merchant ID.

The location of the merchant provides an indication of the location of the payment-card holders based on the assumption that the majority of payment-card holders are physically present at the merchants' location at the time of the “card-present” transaction and remain in the vicinity of the merchants' location after the transaction is complete (i.e. the majority of payment-card holders do not move far away from merchants' location soon after the transaction is complete).

In an implementation, an adequate sample size of transactions is obtained so that it is possible to determine (e.g. using suitable statistical models/techniques) the new locations of the affected population and the number of people at each location. This advantageously enables relief efforts to be more targeted as the new location(s) of the affected population are known. It will be appreciated that the new locations of the affected population and the number of people at each new location obtained using embodiments of the disclosure are not exact but approximates. That is, only an indication of the new locations of the affected population and the number of people at each new location is obtained. For example, a family of four may only make a single transaction at the new location. Thus, the number of transactions may not necessarily provide the corresponding number of people at the new locations. Suitable statistical models/techniques may be used to provide better estimates.

After the location of the merchants are obtained, each of the obtained locations can be ranked based on the transaction data. In one implementation, each of the obtained locations is ranked based on a count of the number of payment-card holders whom have made payment-card transactions with each of the merchants at each of the obtained locations. That is, a merchant that is patronised by the largest number of payment-card holders may be ranked first, based on the assumption that there is a largest proportion of the affected population around the area of that merchant since that merchant is being patronised by the largest number of payment-card holders. Relief efforts can be targeted at locations with the highest population of people affected by the natural disaster.

In another implementation, each of the obtained locations is ranked based on a count of the number of payment-card transactions that have been made with each of the merchants at each of the obtained locations. That is, the obtained location (which may house more than one merchant, e.g. a shopping mall) experiencing the largest number of payment-card transactions may be ranked first, based on the assumption that there is a largest proportion of the affected population around the location of the merchant(s) since the location is experiencing the largest number of payment-card transactions.

Each of the obtained locations can be ranked based on one or more types of transaction data (e.g. type of industry of the merchant, date/time of the transaction, etc.). For example, the obtained location having merchants experiencing the largest number of payment-card transactions within a certain pre-determined time-frame may be ranked first. Ranking may also be based on the number of unique payment-cards that have been used at each of the obtained locations compared to the number used at the location of the natural disaster.

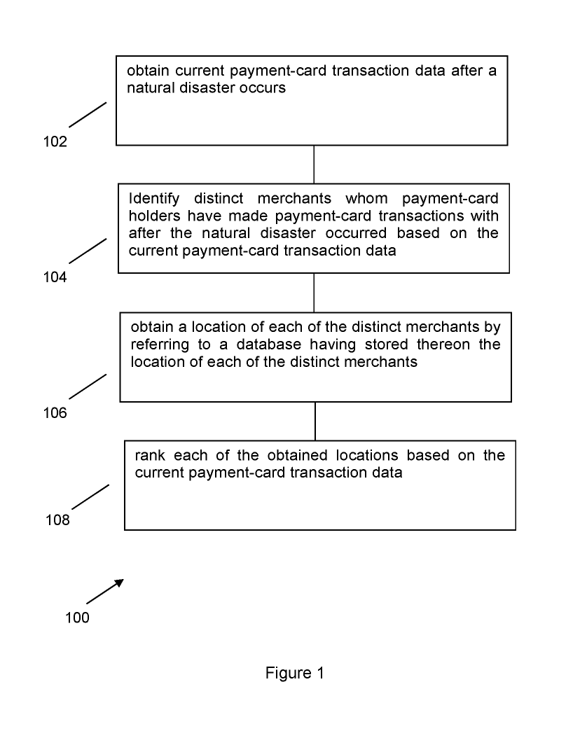

FIG. 1 shows a flow chart 100 illustrating a computer-implemented method for facilitating natural disaster relief planning according to an example embodiment. At block 102, payment-card transaction data is obtained after a natural disaster (calamity) occurs. In an implementation, the time and date of the occurrence of the natural disaster is noted and payment-card transaction data after the date/time is obtained. In the following description, as the payment-card transaction data is obtained after the natural disaster occurs, it is referred to as “current payment-card transaction data”, which is meant to be differentiated from “historical payment-card transaction data” which is payment-card transaction data that is obtained before the natural disaster occurs.

At block 104, at least one merchant (in some embodiments more than one merchant, in other embodiments every merchant) whom payment-card holders have made payment-card transactions with after the natural disaster occurred are identified based on the current payment-card transaction data obtained at block 102. The transaction data that is generated from the payment-card transactions contains, among other information, the identity of the merchant. As such, the merchants whom payment-card holders have made payment-card transactions with after the natural disaster occurred can be identified based on the corresponding identities of the merchant in the transaction data.

If more than one merchant is identified, there may be duplicates. That is, there may be a possibility that a particular merchant is patronized by more than one payment-card holder. As a result, that particular merchant may be identified more than once based on the current payment-card transaction data. Accordingly, in an implementation, duplicates can be removed so that only distinct (i.e. unique) merchants are identified to provide more accurate results.

At block 106, a location of each of the identified merchants (identified at block 104) can be obtained by referring to a database having stored thereon the location of each of the merchants. If duplicate merchants are removed, then only a location of each of the distinct merchants is obtained. The obtained locations of each of the merchants provide an indication of a current location of the payment-card holders after the natural disaster occurs for facilitating natural disaster relief planning. In an implementation, the database contains a list of merchants and their corresponding locations (e.g. postal address and/or latitude/longitude). A look-up procedure may be used to obtain the merchant's location once the merchant is identified. The list of merchants may contain the name of the merchant (“Merchant name”), or merchant identifier (“Merchant ID”), or any suitable identifier capable of uniquely identifying a merchant.

After block 106 is performed, block 108 may be performed. Block 108 involves ranking each of the obtained locations based on the current payment-card transaction data. Natural disaster relief is provided at the obtained locations based on their ranking. For example, a location with a higher rank may be given a higher priority with regard to relief efforts.

For example, each of the obtained locations can be ranked based on a count of the number of payment-card holders whom have made payment-card transactions with each of the (distinct) merchants at each of the obtained locations. There may be a possibility that a particular payment-card holder patronizes a particular merchant more than once. For example, the payment-card holder patronizes the merchant twice in a day as he had forgotten to purchase something the first time. Accordingly, in an implementation, duplicates can be removed so that only distinct (i.e. unique) payment-card holders are counted to provide more accurate results. That is, “double-counting” of payment-card holders due to multiple visits at a merchant is avoided for better accuracy.

Each of the obtained locations may be assigned to one of a plurality of sectors, each sector defining a geographical locality. For example, a sector may define a town, so that each obtained location in that town is assigned that particular sector. This advantageously allows relief efforts to be targeted at a general location (a town, village or city), rather than numerous discrete locations within a town. Thereafter, each of the plurality of sectors can be ranked based on the count of the number of (distinct) payment-card holders whom have made payment-card transactions with each of the (distinct) merchants at each of the obtained locations assigned to the particular sector.

In another example, each of the obtained locations can be ranked based on a count of the number of payment-card transactions that have been made with each of the (distinct) merchants at each of the obtained locations. Each of the obtained locations may be assigned to one of a plurality of sectors, each sector defining a geographical locality. Thereafter, each of the plurality of sectors can be ranked based on the count of the number of payment-card transactions that have been made with each of the (distinct) merchants at each of the obtained locations assigned to the particular sector.

In an implementation, the database may also store the industry-type of each of the merchants. That is, the database contains a list of merchants, their corresponding locations (e.g. postal address and/or latitude/longitude), and their corresponding industry-type (e.g. Merchant Category Code (MCC)). A look-up procedure may be used to obtain the merchant's industry-type once the merchant is identified. The obtained industry-type of each of the merchants provides an indication of industries involved in payment-card transactions after the natural disaster occurred. The obtained industry-type of each of the merchants may be aggregated and then ranked based on the number of transactions. The data corresponding to the number of transactions in a particular industry can be derived from the payment card transaction data. The industries involved in the highest number of transactions (presumably experiencing the highest volume of sales) are ranked first. In this manner, merchants in different industries in the relief areas can plan their inventory and workforce as they receive an indication of which industries are experiencing increased volume of sales after the natural disaster occurs.

In a further implementation, historical payment-card transaction data may be obtained before the natural disaster occurred. The time and date of the occurrence of the natural disaster has been previously noted and payment-card transaction data before the date/time is obtained. Thereafter, at least one merchant (in some embodiments more than one merchant, in other embodiments every merchant) whom the payment-card holders made payment-card transactions with before the natural disaster occurred are identified based on the historical payment-card transaction data. Merchants identified here may be referred to as “additional merchants” to differentiate these merchants from those identified at block 104 above. The “additional merchants” may, in some instances, be different entities from the “merchants” identified at block 104 above. In other instances, the “additional merchants” may be the same entities as the “merchants” identified at block 104 above. In an implementation, duplicates can be removed so that only distinct (i.e. unique) additional merchants are identified to provide more accurate results.

Similar to block 104 above, the historical transaction data that is generated from the payment-card transactions contain, among other information, the identity of the additional merchant. As such, the additional merchants whom payment-card holders have made payment-card transactions with before the natural disaster occurred can be identified based on the corresponding identities of the additional merchant.

Thereafter, a location of each of the identified additional (distinct) merchants can be obtained by referring to the database further having stored thereon the location of each of the additional (distinct) merchants. The obtained locations of each of the additional merchants provide an indication of a previous location of the payment-card holders before the natural disaster occurred for facilitating natural disaster relief planning.

In an implementation, the location of each of the (distinct) merchants (obtained at block 106 above) is compared with the location of each of the additional (distinct) merchants to provide an indication of movement of the payment-card holders due to the natural disaster. Once the new location(s) of the payment-card holders after the natural disaster is determined, it means that the affected population has moved to the new location(s) and hence relief efforts can be targeted at the new location(s). Also, relief camps may be set up along the route of movement of the affected population. Further, using suitable techniques, it may be possible to predict future movement of the payment-card holder based on the movement pattern of the payment-card holder.

In an implementation, the locations of each of the merchants (and additional merchants) may comprise geographical location data (e.g. latitude/longitude coordinates, postal address, etc.) corresponding to the merchant's premises (or the additional merchant's premises, respectively).

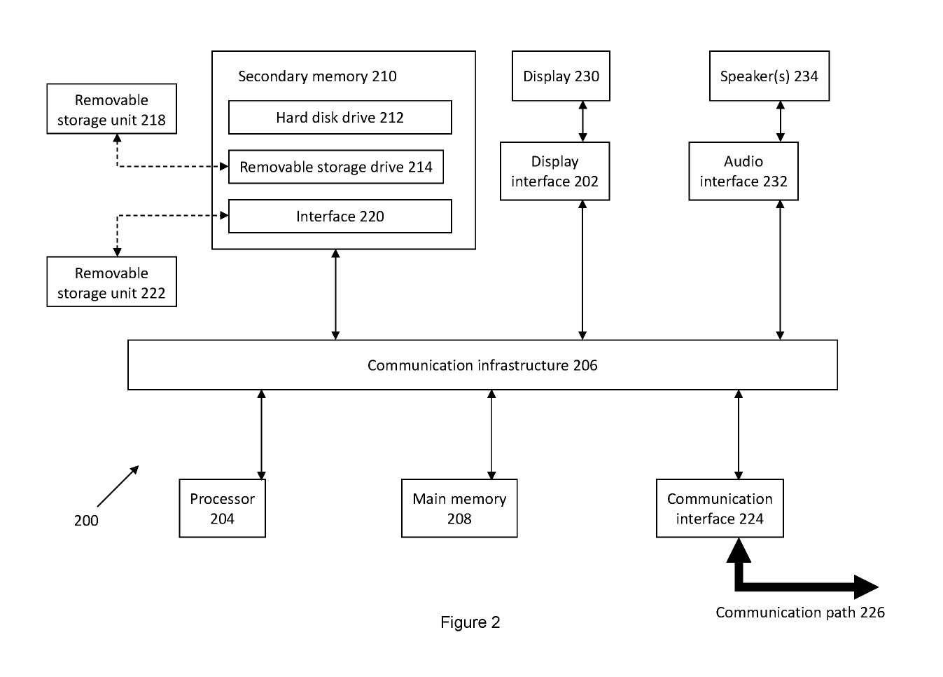

FIG. 2 depicts an exemplary computing device 200, hereinafter interchangeably referred to as a computer system 200, where one or more such computing devices 200 may be used to execute the above-described method for locating a payment-card holder and/or facilitating natural disaster relief planning. The following description of the computing device 200 is provided by way of example only and is not intended to be limiting.

As shown in FIG. 2, the example computing device 200 includes a processor 204 for executing software routines. Although a single processor is shown for the sake of clarity, the computing device 200 may also include a multi-processor system. The processor 204 is connected to a communication infrastructure 206 for communication with other components of the computing device 200. The communication infrastructure 206 may include, for example, a communications bus, cross-bar, or network.

The computing device 200 further includes a main memory 208, such as a random access memory (RAM), and a secondary memory 210. The secondary memory 210 may include, for example, a hard disk drive 212 and/or a removable storage drive 214, which may include a magnetic tape drive, an optical disk drive, or the like. The removable storage drive 214 reads from and/or writes to a removable storage unit 218 in a well-known manner. The removable storage unit 218 may include a magnetic tape, optical disk, or the like, which is read by and written to by removable storage drive 214. As will be appreciated by persons skilled in the relevant art(s), the removable storage unit 218 includes a computer readable storage medium having stored therein computer executable program code instructions and/or data.

In an alternative implementation, the secondary memory 210 may additionally or alternatively include other similar means for allowing computer programs or other instructions to be loaded into the computing device 200. Such means can include, for example, a removable storage unit 222 and an interface 220. Examples of a removable storage unit 222 and interface 220 include a program cartridge and cartridge interface (such as that found in video game console devices), a removable memory chip (such as an EPROM or PROM) and associated socket, and other removable storage units 222 and interfaces 220 which allow software and data to be transferred from the removable storage unit 222 to the computer system 200.

The computing device 200 also includes at least one communication interface 224. The communication interface 224 allows software and data to be transferred between computing device 200 and external devices via a communication path 226. In various embodiments of the disclosure, the communication interface 224 permits data to be transferred between the computing device 200 and a data communication network, such as a public data or private data communication network. The communication interface 224 may be used to exchange data between different computing devices 200 which such computing devices 200 form part an interconnected computer network. Examples of a communication interface 224 can include a modem, a network interface (such as an Ethernet card), a communication port, an antenna with associated circuitry and the like. The communication interface 224 may be wired or may be wireless. Software and data transferred via the communication interface 224 are in the form of signals which can be electronic, electromagnetic, optical or other signals capable of being received by communication interface 224. These signals are provided to the communication interface via the communication path 226.

As shown in FIG. 2, the computing device 200 may further include a display interface 202 which performs operations for rendering images to an associated display 230 and an audio interface 232 for performing operations for playing audio content via associated speaker(s) 234.

As used herein, the term “computer program product” may refer, in part, to removable storage unit 218, removable storage unit 222, a hard disk installed in hard disk drive 212, or a carrier wave carrying software over communication path 226 (wireless link or cable) to communication interface 224. Computer readable storage media refers to any non-transitory tangible storage medium that provides recorded instructions and/or data to the computing device 200 for execution and/or processing. Examples of such storage media include magnetic tape, CD-ROM, DVD, Blu-ray™ Disc, a hard disk drive, a ROM or integrated circuit, USB memory, a magneto-optical disk, or a computer readable card such as a SD card and the like, whether or not such devices are internal or external of the computing device 200. Examples of transitory or non-tangible computer readable transmission media that may also participate in the provision of software, application programs, instructions and/or data to the computing device 200 include radio or infra-red transmission channels as well as a network connection to another computer or networked device, and the Internet or Intranets including e-mail transmissions and information recorded on Websites and the like.

The computer programs (also called computer program code) are stored in main memory 208 and/or secondary memory 210. Computer programs can also be received via the communication interface 224. Such computer programs, when executed, enable the computing device 200 to perform one or more features of embodiments discussed herein. In various embodiments, the computer programs, when executed, enable the processor 204 to perform features of the above-described embodiments. Accordingly, such computer programs represent controllers of the computer system 200.

Software may be stored in a computer program product and loaded into the computing device 200 using the removable storage drive 214, the hard disk drive 212, or the interface 220. Alternatively, the computer program product may be downloaded to the computer system 200 over the communications path 226. The software, when executed by the processor 204, causes the computing device 200 to perform functions of embodiments described herein.

It is to be understood that the embodiment of FIG. 2 is presented merely by way of example. Therefore, in some embodiments one or more features of the computing device 200 may be omitted. Also, in some embodiments, one or more features of the computing device 200 may be combined together. Additionally, in some embodiments, one or more features of the computing device 200 may be split into one or more component parts.

It will be appreciated that the elements illustrated in FIG. 2 function to provide means for performing the various, methods, functions and operations as described in the above embodiments.

In an embodiment, there is provided an apparatus for facilitating natural disaster relief planning, the apparatus comprising: at least one processor; and at least one memory including computer program code; the at least one memory and the computer program code configured to, with at least one processor, cause the apparatus at least to: obtain current payment-card transaction data after a natural disaster occurs; identify distinct merchants whom payment-card holders have made payment-card transactions with after the natural disaster occurred based on the current payment-card transaction data; obtain a location of each of the distinct merchants by referring to a database having stored thereon the location of each of the distinct merchants; and rank each of the obtained locations based on the current payment-card transaction data, wherein natural disaster relief is provided at the obtained locations based on their ranking.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

1. A computer-implemented method for facilitating natural disaster relief planning, comprising:
obtaining current payment-card transaction data after a natural disaster occurs;
identifying distinct merchants whom payment-card holders have made payment-card transactions with after the natural disaster occurred based on the current payment-card transaction data;
obtaining a location of each of the distinct merchants by referring to a database having stored thereon the location of each of the distinct merchants; and
ranking each of the obtained locations based on the current payment-card transaction data, wherein natural disaster relief is provided at the obtained locations based on their ranking.

2. The method as claimed in claim 1, wherein each of the obtained locations is ranked based on a count of the number of distinct payment-card holders who have made payment-card transactions with each of the distinct merchants at each of the obtained locations.

3. The method as claimed in claim 2, further comprising:
assigning each of the obtained locations to one of a plurality of sectors, each sector defining a geographical locality; and
ranking each of the plurality of sectors based on the count of the number of distinct payment-card holders who have made payment-card transactions with each of the distinct merchants at each of the obtained locations assigned to the sector.

4. The method as claimed in claim 1, wherein each of the obtained locations is ranked based on a count of the number of payment-card transactions that have been made with each of the distinct merchants at each of the obtained locations.

5. The method as claimed in claim 4, further comprising:
assigning each of the obtained locations to one of a plurality of sectors, each sector defining a geographical locality; and
ranking each of the plurality of sectors based on the count of the number of payment-card transactions that have been made with each of the distinct merchants at each of the obtained locations assigned to the sector.

6. The method as claimed in claim 5, further comprising obtaining an industry-type of each of the distinct merchants by referring to the database further having stored thereon the industry-type of each of the distinct merchants, wherein the obtained industry-type of each of the distinct merchants provide an indication of industries involved in payment-card transactions after the natural disaster occurred.

7. The method as claimed in claim 6, comprising:
obtaining historical payment-card transaction data before the natural disaster occurred;
identifying additional distinct merchants whom the payment-card holders have made payment-card transactions with before the natural disaster occurred based on the historical payment-card transaction data;
obtaining a location of each of the additional distinct merchants by referring to the database further having stored thereon the location of each of the additional distinct merchants; and
comparing the location of each of the distinct merchants with the location of each of the additional distinct merchants to provide an indication of movement of the payment-card holders due to the natural disaster.

8. The method as claimed in claim 7, wherein each of the obtained locations comprise geographical location data corresponding to the distinct merchant's premises.

9. The method as claimed in claim 8, wherein the geographical location data comprises one or more of: (i) a latitude and longitude, and (ii) postal address.

10. The method as claimed in claim 9, wherein the current payment-card transaction data comprises a merchant identity for uniquely identifying each of the distinct merchants.

11. The method as claimed in claim 10, further comprising storing, in the database, the merchant identity in association with the corresponding location of the distinct merchant.

12. An apparatus for facilitating natural disaster relief planning, the apparatus comprising:
at least one processor; and
at least one memory including computer program code;
the at least one memory and the computer program code configured to, with at least one processor, cause the apparatus at least to:
obtain current payment-card transaction data after a natural disaster occurs;
identify distinct merchants whom payment-card holders have made payment-card transactions with after the natural disaster occurred based on the current payment-card transaction data;
obtain a location of each of the distinct merchants by referring to a database having stored thereon the location of each of the distinct merchants; and
rank each of the obtained locations based on the current payment-card transaction data, wherein natural disaster relief is provided at the obtained locations based on their ranking.
